(19) United States
(12) Patent Application Publication
(10) Pub. No.: US 2007/0092036 A1
(43) Pub. Date: Apr. 26, 2007

(54) 8-Vsb like backward-compatible robust stream modulation for atsc digital tv transmission

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/560,851

(22) PCT Filed: Jun. 8, 2004
(86) PCT No.: PCT/IB04/50865

§ 371 Date: Dec. 5, 2005

Related U.S. Application Data
(60) Provisional application No. 60/477,200, filed on Jun. 10, 2003.
(60) Provisional application No. 60/541,454, filed on Feb. 3, 2004.

(51) Int. Cl. H04L 27/04

(52) U.S. Cl. 375/301

(57) ABSTRACT

A system and method is provided for generating backward compatible robust ATSC 8-VSB bit streams for transmission by a digital transmitter. A backward compatible robust digital TV modulation technique is employed where a multiplexed stream of bits is encoded such that the constellation is similar to a standard 8-VSB constellation.

The present invention relates to modifying an American Television Standards Committee (ATSC) digital TV signal in a backward compatible manner to enable broadcasting a signal that has a different degree of robustness together with the existing signal.

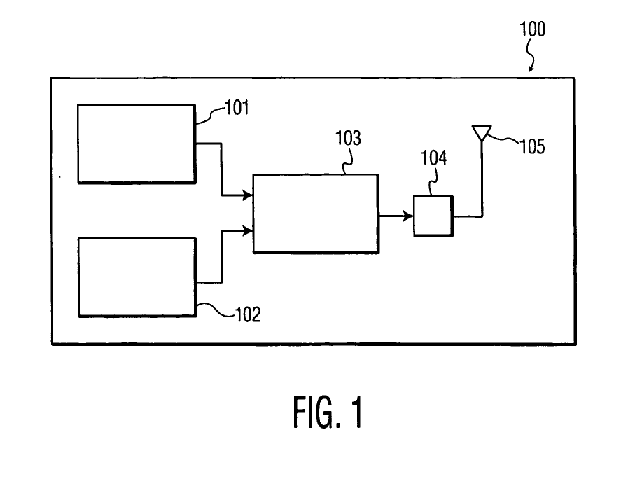

The ATSC transmission format for digital television (DTV) uses and 8 level vestigial sideband (8-VSB) technique in which each successive 3 bit symbol is transmitted as one of 8 possible signal amplitudes. There has recently been a growing interest in modifying the ATSC DTV standard in a backward compatible manner so that broadcasters can broadcast a signal that has a different degree of robustness together with an existing signal. The key to achieving robustness in a backward compatible manner lies in the signal processing of the error correction part of the transmitter. A top level diagram of the mixing of a robust stream with a standard stream is shown in FIG. 1.

The 8-VSB ATSC standard uses signals mapped to one of the eight levels:
(−7, −5, −3, −1, 1, 3, 5, 7).
This is called an equiprobable 8-VSB signal. One of the known approaches for encoding a robust stream is to reduce the alphabet size from 8 levels to 4 levels. For example, possibilities exist to use:
{−7,−5, 5, 7}, or
{−7,−1, 3, 5}, or
{−5,−3, 1, 7}, etc.

When the alphabet size is reduced from eight to four, the performance of the system improves because the distance between permissible signal levels is greater, so that the transmitted signal is less susceptible to noise and distortions. One of the disadvantages of such reduced-alphabet systems is that they potentially have backward compatibility problems. Receivers that are designed based on the eight-level statistics may show some degradation.

Thus there is a need for an approach to transmitting a robust symbol stream in conjunction with a normal stream that is backward compatible.

The system and method of the present invention applies multiple modulation types in a single stream of standard and robust symbols in such a way that the statistics of the output signal look like a standard 8-VSB signal. If, for example, according to the present invention one of the set of constellation points
{−7,−1, 3, 5} or
{−5,−3, 1, 7}
is randomly selected to modulate each symbol of a robust stream, the average output signal will look like a standard 8-VSB signal because the set union of the 4-level alphabet constellation point sets {−7,−1, 3, 5} and {−5,−3, 1, 7} is the eight level constellation point set {−7,−1, 3, 5,−5,−3, 1, 7}.

FIG. 1 illustrates the mixing a robust stream with a standard stream of a standard ATSC digital TV signal.

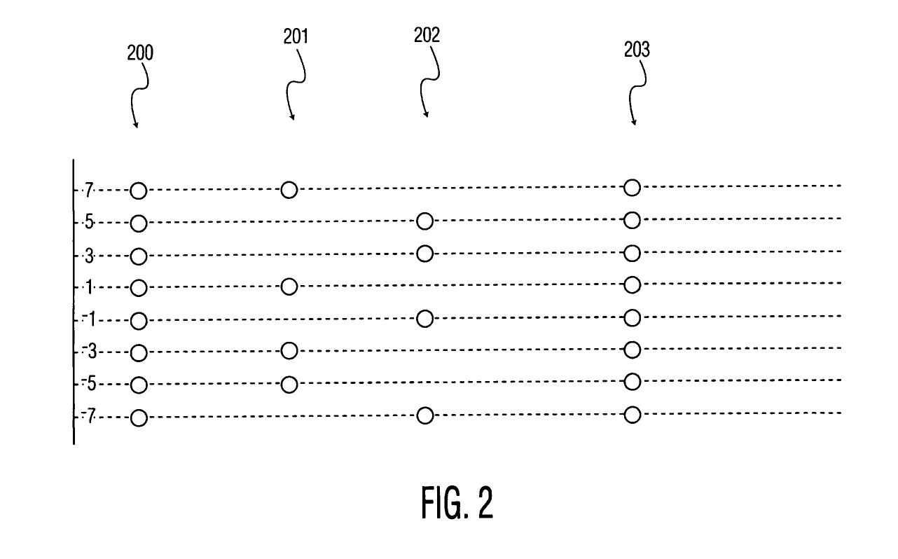

FIG. 2 illustrates the constellation diagrams.

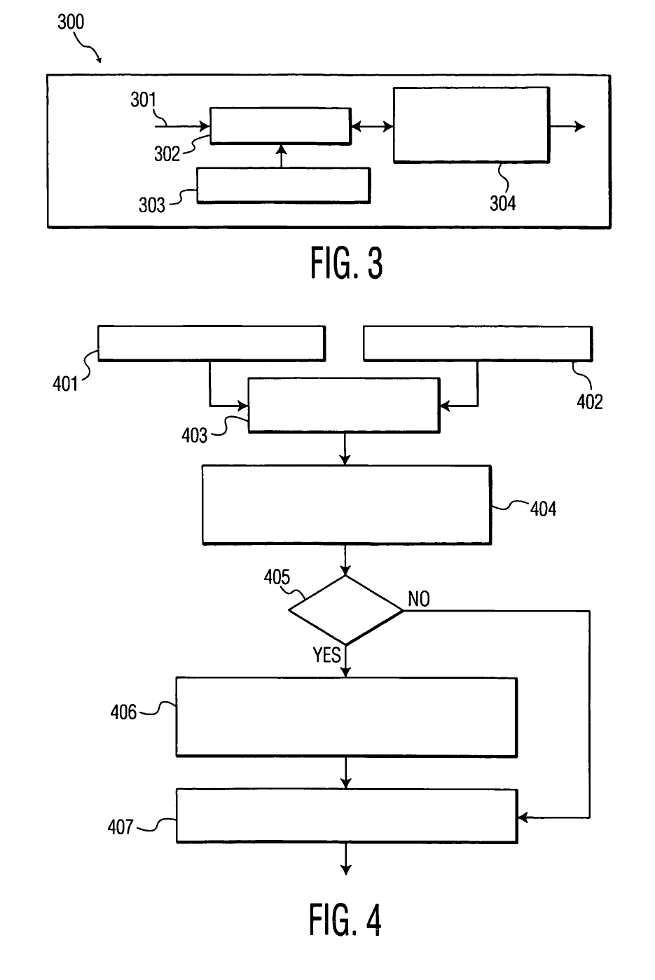

FIG. 3 illustrates a simplified top-level diagram of the last stage of an ATSC VSB encoder modified according to the present invention.

FIG. 4 illustrates a high level flow diagram for the part of the last stage of an ATSC VSB encoder modified according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

Referring now to FIG. 2, if the set of constellation points {−5,−3, 1, 7} 201 or {−7,−1, 3, 5} 202, are randomly selected to modulate each symbol of the robust stream in a multiplexed manner, the average signal 203 looks like a standard 8-VSB signal 200.

Referring now to FIG. 3, the constellations are achieved by manipulating the input to the trellis encoder 304 of a standard 8-VSB system 300. For a given robust stream symbol, the control sequence generator 303 instructs the pre-processor 302 to generate the appropriate bits such that when these bits are input to the standard trellis encoder 304, the output of this standard trellis encoder 304 is forced to be one of the desired 8-VSB constellation points.

Thus, the standard trellis encoder device 304 produces a stream of trellis encoded bits corresponding to bits of the multiplexed stream of input bits and additionally maps the trellis encoded bits into symbols so that multiple modulation types are employed in a single stream in such a way that the statistics of the output signal look like a standard 8-VSB signal.

In the present invention, robust and existing standard bit streams are mixed in a backward compatible manner such that a signal that has a different degree of robustness can be transmitted together with an existing signal thus allowing better reception of ATSC digital TV signals.

Referring now to FIG. 4, a standard stream symbol is received 401 or a robust stream symbol is received 402 and is multiplexed 403 into a single stream and output to a pre-processor 302. A control sequence generator 303 continually monitors and identifies 404 the type of symbol of the multiplexed stream that is entering the pre-processor 302. For each robust symbol identified 405, the control sequence generator 303 instructs the pre-processor to generate appropriate bits 406 to force the standard trellis encoder 304 to output one of the 8-VSB constellation points.

Preferably, the control sequence generator 303 directs generation of bits by the pre-processor 302 that force the standard trellis encoder 304 to produce an averaged constellation 203 that is substantially a standard 8-VSB constellation 200 by randomly selecting one of a pair 201 202 of reduced 4-level alphabets that together average to a standard 8-VSB constellation 203. That is, the resulting data stream contain normal data multiplexed with robust data such that statistics of the data stream are such that it appears to be a standard 8-VSB stream.

Thus, the present invention is embodied in the ATSC-compliant embedding of information bearing symbols in a data stream and creates a more robust tier of service while maintaining backward compatibility with existing ATSC-compliant receivers and transmitters. The four requirements for such backward compatibility with legacy 8-VSB ATSC systems are satisfied by the system and method of the present invention:
1. robust data appears at the receiver to have the characteristics of an 8-VSB signal;
2. robust data uses the existing trellis encoder at the transmitter and the existing trellis decoder at the receiver;
3. robust data generates valid Reed Solomon parity bytes so that existing receivers do not flag robust data as having Reed Solomon parity errors; and
4. robust data maintains the MPEG format and does not destabilize the existing MPEG decoder.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teachings of the present invention to a particular situation without departing from its central scope. For example, the manner in which the control sequence generator 301 instructs the pre-processor 302 may vary. Therefore, it is intended that the present invention not be limited to the particular embodiments disclosed as the best mode contemplated for carrying out the present invention, but that the present invention include all embodiments falling within the scope of the appended claims.

1. A method of modulating a multiplexed stream (301) of robust (102) (402) and standard symbols (101) (401), comprising the steps of:
providing a first (201) (202) and a second (200) set of constellation points such that the statistics (203) of an output signal modulated with a randomly selected one of said first set (201) (202) of constellation points look like the statistics of an output signal modulated with said second set (200) of constellation points;
modulating (304) each robust symbol of said multiplexed stream (301) with a randomly selected (406) one of said provided first set of constellation points (407); and
modulating (304) each standard symbol of said multiplexed stream with a one of the provided constellation points of said second set of constellation points (407).

2. The method according to claim 1, wherein the second predetermined set of constellation points is an 8 level vestigial sideband (8-VSB) ATSC standard set of eight constellation points (103).

3. The method according to claim 2, wherein the eight constellation points are {−7,−5,−3,−1, 1, 3, 5, 7} (200).

4. The method according to claim 3, wherein the the first pre-determined set of constellation points is randomly chosen from the set of {{−7,−5,−3,−1},{1, 3, 5, 7}} (201) (202).

5. The method according to claim 1, wherein:
the step of modulating each robust symbol comprises the substeps of
i. generating bits (406) to force a standard trellis encoder to output the randomly selected one of the first pre-determined set of constellation points,
ii. inputting the robust symbol and the generated bits to a standard trellis encoder (407), and
iii. modulating the robust symbol by the standard trellis encoder (407) with the randomly selected one of the constellation points of the first predetermined set of constellation points; and
the step of modulating each standard symbol comprises the substeps of
iv. inputting the standard symbol to the standard trellis encoder (407), and
v. modulating the standard symbol by the standard trellis encoder (407) with the one of the constellation points of the second pre-determined set of constellation points.

6. The method according to claim 5, wherein the second predetermined set of constellation points is an 8 level vestigial sideband (8-VSB) ATSC standard set of eight constellation points {−7,−5,−3, −1, 1, 3, 5, 7} (200).

7. The method according to claim 6, wherein the first pre-determined set of constellation points is randomly chosen from the set of {{−7,−5,−3,−1},{1, 3, 5, 7}} (201) (202).

8. A method for providing backward-compatible modulation, comprising the steps of:
providing a multiplexed stream of at least one standard and at least one robust symbol (403); and
modulating said multiplexed stream using multiple modulation types am such that the statistics of the output signal look like a standard signal (103) (404)-(407).

9. The method according to claim 8, further comprising the step of broadcasting (105) said modulated stream as an ATSC digital TV signal.

10. The method according to claim 8, wherein the step of modulating further comprises the substeps of:
randomly selecting one of the set of constellation points (406) {{−7,−5,−3,−1},{1, 3, 5, 7}} (201) (202) to modulate (407) each said at least one robust symbol of the stream; and
modulating each said at least one standard symbol (407) using the set of constellation points {−7,−5,−3,−1, 1, 3, 5, 7} (200).

11. The method according to claim 10, further comprising the step of broadcasting (105) said modulated stream as an ATSC digital TV signal.

12. An apparatus for 8-VSB like backward-compatible stream modulation, comprising:
a preprocessor (302) for receiving a multiplexed stream (301) of at least one standard symbol and at least one robust symbol;
a standard trellis encoder (304) operably interfaced to the preprocessor for encoding/mapping the multiplexed stream using multiple modulation types;
a control sequence generator (303) operably connected to the preprocessor to direct the preprocessor to force the standard trellis encoder (304) to output one of a pre-determined set of constellation points (201) (202) for each said at least one robust symbol such that statistics of an encoded/mapped stream output by the trellis encoder (304) look like statistics of a standard 8-VSB stream (203).

13. The apparatus according to claim 12, wherein the pre-determined set of constellation points is selected from one of a randomly chosen set of {{−7,−5,−3,−1},{3, 5, 7}} (201) (202).
